(19) United States
(12) Patent Application Publication
(10) Pub. No.: US 2005/0280503 A1
(43) Pub. Date: Dec. 22, 2005

(54) Semiconductor wafer having identification unit and method of identifying the semiconductor wafer using the identification unit

(76) Inventors: Sang-Woo Lee, Cheonan-si (KR); Cheol-Joon Yoo, Cheonan-si (KR); Dong-Bin Kim, Cheonan-si (KR)

Correspondence Address: HARNESS, DICKEY & PIERCE, P.L.C., P.O. BOX 8910, RESTON, VA, 20195, US

(21) Appl. No.: 11/147,314

(22) Filed: Jun. 8, 2005

(30) Foreign Application Priority Data
Jun. 16, 2004 (KR) 2004-44495

(51) Int. Cl. H04Q 5/22

(52) U.S. Cl. 340/10.1; 340/572.1; 340/10.51

(57) ABSTRACT

A semiconductor wafer, comprising a radio frequency identification (RFID) chip on one side of the semiconductor wafer, on which a pattern has been formed, wherein information on the wafer is input to and/or output from the RFID chip using radio frequency communication.

### PRIORITY STATEMENT

This application claims the priority of Korean Patent Application No. 2004-44495, filed on Jun. 16, 2004, in the Korean Intellectual Property Office, the disclosure of which is incorporated herein in its entirety by reference.

### BACKGROUND OF THE INVENTION

1. Field of the Invention

The present invention relates to a semiconductor wafer and a method of identifying the semiconductor wafer. More specifically, the present invention is directed to a semiconductor wafer including a radio frequency identification (RFID) chip, with which information on the semiconductor wafer can be identified on a real-time basis, and a method of identifying the semiconductor wafer using the RFID chip.

2. Description of the Related Art

Product management in a semiconductor assembly and packaging process may be practiced based on information on a wafer (hereinafter referred to as ‘wafer information’). Product flow from wafer processing to packaging may be managed based on the wafer information.

FIG. 1 is a planar view illustrating a conventional wafer with adhesive tape marked with wafer information.

The wafer information may be marked on a part of a wafer 10 with a combination mark 12 which is a combination of a series of characters and numerals. The combination mark 12 may include a variety of information on the wafer 10, such as wafer alignment data and/or rejection information. The combination mark 12 may be made during a photolithography process.

The wafer 10 may be sawed into chips after an electrical die sorting (EDS) test, for semiconductor components, is formed on the wafer 10. Dicing tape 14, a type of adhesive tape, may be attached to a side of the wafer 10 with no pattern. A tag 16 may indicate that the wafer information is marked with a barcode-like pattern on,an exposed part of the dicing tape 14. The tag 16 may further include the EDS test results.

The wafer information may be stored in both the combination mark 12 and/or the tag 16, which may be read by a reader including a photo sensor, etc. However, the wafer information may be incorrectly identified due to alterations caused by etching the wafer 10 and/or uneven dicing tape 14. In addition, the reader may incorrectly identify the wafer information due to misalignment of the reader. Furthermore, processes may be stopped for a period of time to identify the wafer information.

### SUMMARY OF THE INVENTION

Exemplary embodiments of the present invention provide a semiconductor wafer having an identification unit for identifying wafer information on a real-time basis.

Exemplary embodiments of the present invention also provide a method of identifying wafer information on a real-time basis.

According to an exemplary embodiment of the present invention, a semiconductor wafer may include an radio frequency identification (RFID) chip on one side of the semiconductor wafer, on which a pattern has been formed. Information on the wafer may be input to and/or output from the RFID chip using radio frequency (RF) communication.

In an exemplary embodiment, the wafer information may be a history of various processes that the semiconductor wafer was subjected to during fabrication/manufacturing.

The RFID chip may comprise a data receiving unit which may receive the wafer information and a data transmitting unit which may transmit the wafer information. The RFID chip may also comprise a data storage unit which stores the wafer information.

The RFID chip may be formed during processing the wafer. In an exemplary embodiment, the RFID chip may be attached to the wafer using an adhesive. In an exemplary embodiment, the RFID chip may be inserted into a recess in the wafer. In an exemplary embodiment, the recess may have a depth of 40 μm or less.

According to another exemplary embodiment of the present invention, a method of identifying a semiconductor wafer may comprise storing a first wafer information in a database; inputting the first wafer information to an RFID chip formed on the wafer, reading a second wafer information using a reader, and determining whether the first wafer information in the database is identical to the second wafer information in the RFID chip and proceeding to a wafer processing operation if the result is determined to be identical.

In an exemplary embodiment, inputting wafer information may comprise receiving an RF signal containing the first wafer information and occupying a frequency band in an antenna unit, generating a power source with a voltage from the RF signal in a power generating unit, converting the RF signal into a digital signal; analyzing data transmitted from the data receiving unit in a data processing unit, and storing data analyzed in the data processing unit.

In an exemplary embodiment, the inputting of the wafer information may be performed on a real-time basis.

In an exemplary embodiment, a reference point for coordinates required for inputting the wafer information may be the RFID chip.

In an exemplary embodiment, the wafer information may be input before and after the EDS test.

In an exemplary embodiment, the reading of the wafer information may comprise extracting the second wafer information from the data storage unit, transmitting the second wafer information converted into an analog signal in a data transmitting unit to the antenna unit, emitting the analog signal bearing the second wafer information from the antenna unit, and reading the analog signal emitted.

In an exemplary embodiment, the reading of the wafer information may be performed on a real-time basis.

In an exemplary embodiment, a control unit may determine whether the wafer information in the database is identical to the wafer information in the RFID chip.

In an exemplary embodiment, a semiconductor wafer identification system may comprise a radio frequency identification (RFID) chip for storing wafer information and a reader for reading the wafer information stored on the RFID chip.

In an exemplary embodiment, a radio frequency identification (RFID) chip comprising an antenna unit transmitting and/or receiving an RF signal, a power generating unit generating a power source with a voltage from the RF signal received through the antenna unit, a data receiving unit converting the RF signal received in the antenna unit into a digital signal and transmitting the converted signal to the data processing unit, a data storage unit storing data received from the data receiving unit, a data processing unit processing data received from the data receiving unit, and a data transmitting unit transmitting the processed data to a reader.

### BRIEF DESCRIPTION OF THE DRAWINGS

The present invention will become more apparent from the description of exemplary embodiments that follows, with reference to the attached drawings in which:

FIG. 1 is a planar view illustrating a conventional semiconductor wafer and adhesive tape marked with wafer information;

FIG. 2 is a sectional view illustrating a semiconductor wafer including with an RFID chip according to an example embodiment of the present invention;

FIG. 3 is a schematic block diagram illustrating an RFID identification system according to an example embodiment of the present invention;

FIGS. 4A through 4C are sectional views illustrating a method of forming an RFID chip on a semiconductor wafer according an example embodiment of to the present invention;

FIG. 5 is a flowchart illustrating a method of identifying a semiconductor wafer according to an example embodiment of the present invention; and

FIG. 6 is a perspective view illustrating a method of identifying a semiconductor wafer according to an example embodiment of the present invention.

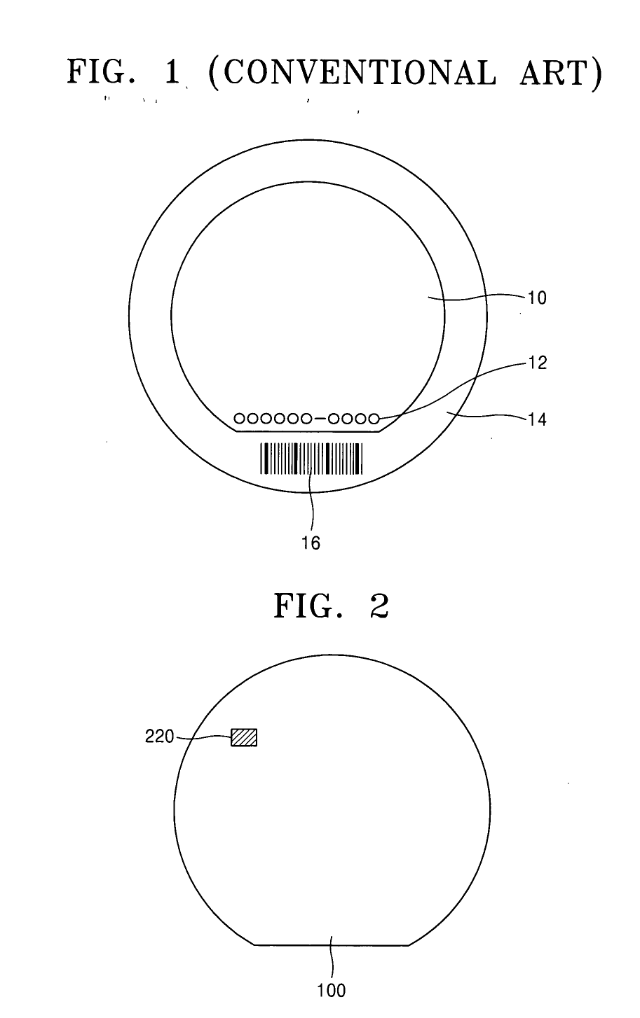

### DETAILED DESCRIPTION OF EXEMPALRY EMBODIMENTS OF THE INVENTION

Exemplary embodiments according to the present invention will now be described in detail with reference to the accompanying drawings.

FIG. 2 is a sectional view illustrating a semiconductor wafer including with an RFID chip according to an example embodiment of the present invention.

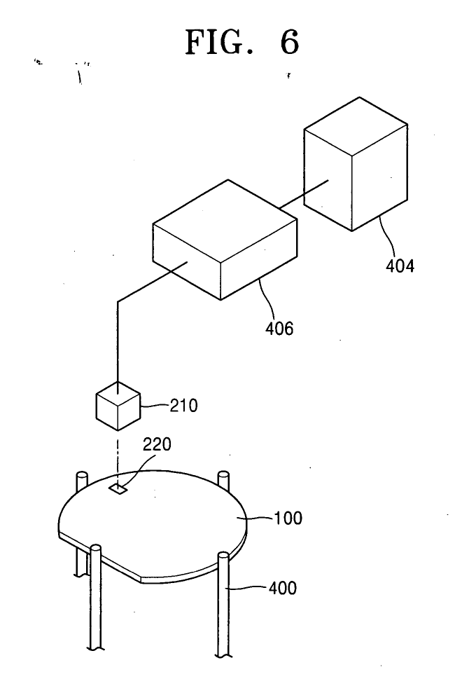

An RFID chip 220 may be formed on a part of a semiconductor wafer 100. RFID is a technology that may enable electronic labeling and wireless identification of objects using radio frequency communications and/or a subset of the broader area of Automatic Identification and Data Capture (AIDC) technologies. These techniques may include barcodes, optical character identification, and/or infrared identification systems. After information stored in the RFID chip 220 is identified with an antenna 222, a control unit (reference numeral 406 in FIG. 6) may analyze the identified information, which may be used to obtain wafer information stored in the RFID chip 220. Since the RFID chip 220 uses frequencies, the RFID chip 220 may be not affected by external environments such as snow, rain, wind, dust, or magnetic flux. In addition, the RFID chip 220 may be identified during movement and/or at a long distance. Because the RFID chip 220 may be given a unique identification number during a semiconductor fabricating process, the RFID chip 220 may not be counterfeited. Accordingly, an incorrect identification of the wafer information seldom occurs as compared with a conventional barcode or optical character identification (OCR) system. In addition, the RFID chip 220 may not require additional time for inputting or identifying the wafer information since the wafer information may be inputted or identified in real-time.

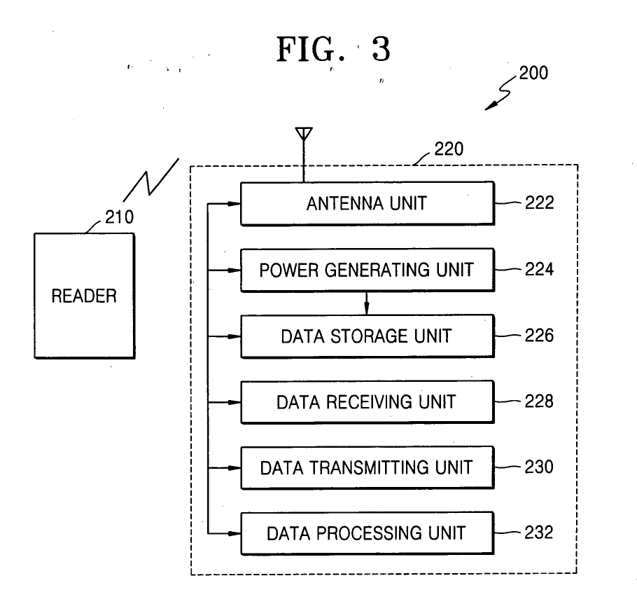

FIG. 3 is a schematic block diagram illustrating an RFID identification system according to an example embodiment of the present invention.

The RFID identification system 200 may comprise a reader 210 and/or an RFID chip 220. The RFID chip 220 may comprise an antenna unit 222 for transmitting and/or receiving an RF signal, which may occupy a frequency band, a power generating unit 224, which may generate a power source with a voltage from the RF signal received through the antenna unit 222, a data receiving unit 228, which may convert the RF signal received in the antenna unit 222 into a digital signal and/or may transmit the converted signal to a data processing unit 232, a data storage unit 226, which may store the analyzed data, a data transmitting unit 230, which may convert the data in the data storage unit 226 into an analog signal and may transmit the analog signal to the antenna unit 222, and a data processing unit 232, which may process the data.

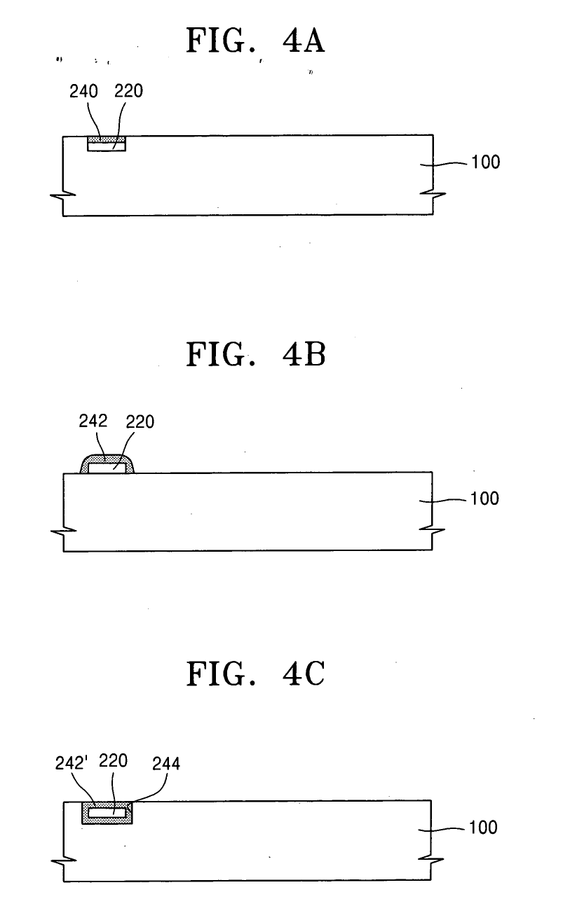

FIGS. 4A through 4C are sectional views illustrating a method of forming an RFID chip on a semiconductor wafer according to an example embodiment of the present invention.

Referring to FIG. 4A, the RFID chip 220 may be attached to a wafer 100 in various ways. For example, the RFID chip 220 may be formed by directly processing the wafer 100. The RFID chip 220 may be simultaneously fabricated during the process of fabricating a memory. A protective film 240 may be formed on the RFID chip 220 in order to protect the RFID chip 220 from the external environment. The protective film 240 may be a silicon oxide film.

In another example embodiment, the RFID chip 220 may be attached to the wafer 100 using an adhesive 242 as shown in FIG. 4B. The adhesive 242 may be any one of pressure-sensitive acrylic, silicon, and urethane adhesives. In addition, the RFID chip 220 may be attached to the wafer 100 using epoxy adhesives. The adhesive 242 may function to fix the RFID chip 220 to the wafer 100 and/or to protect the RFID chip 220 from the external environments.

In another example embodiment, the chip 220 may be inserted into a recess 244 formed on the wafer 100 as shown in FIG. 4C. The RFID chip 220 may be fixed in the recess 244 using an adhesive 242. The recess 244 may have a depth of 40 μm or less and the wafer 100 may have a thickness of approximately 50 μm.

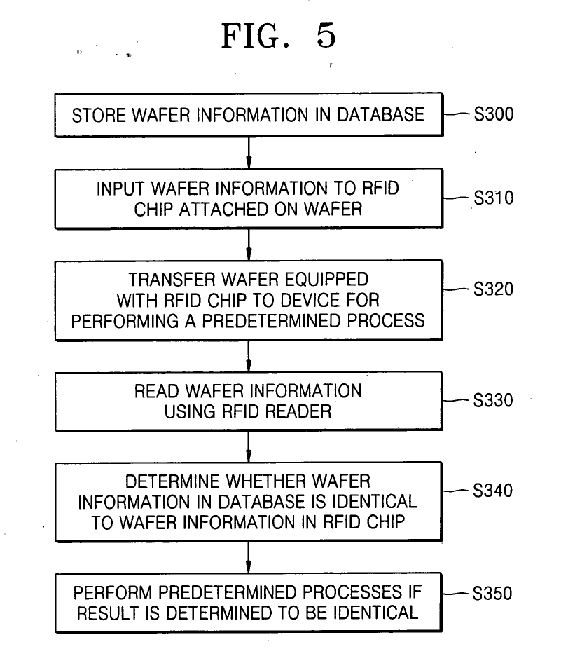

FIG. 5 is a flowchart illustrating a method of identifying a semiconductor wafer according to an example embodiment of the present invention. FIG. 6 is a perspective view illustrating a method of identifying a semiconductor wafer according to an example embodiment of the present invention.

The wafer information may be stored in a database 404 in advance (S300). The wafer information may be a history of various processes that the semiconductor wafer was subjected to during fabrication and/or manufacturing, such as a unique identification number of the wafer, data required for wafer alignment, information on a defective component, etc. An unique identification number of a wafer may be made up of a series of characters or numerals indicating wafer grade, wafer use, manufacture date, puller serial number, ingot serial number, location on ingot, wafer serial number, and/or manufacturer name.

The wafer information may be input into the RFID chip 220 on the wafer 100 (S310). The process of inputting the wafer information to the RFID chip 220 may be as follows. The antenna unit 222 may receive an RF signal occupying a frequency band. The wafer 100 may be placed on an alignment station 400. A voltage source may be generated from the RF signal received by the antenna unit 222 in the power generating unit 224. The RF signal may be received in the antenna unit 222, which may be converted into a digital signal in the data receiving unit 228. The data transmitted from the data receiving unit 228 may be analyzed in the data processing unit 232. The data analyzed in the data processing unit 232 may be stored in the data storage unit 226.

The wafer information may be input before and/or after an EDS test. Before the EDS test, information on defective semiconductor components produced during a process of forming semiconductor components may be inputted to the RFID chip 220 in real-time. After the EDS test, information on electrical defects in semiconductor components may be further included. A reference point for coordinates required for inputting the wafer information may be on the RFID chip 220. That is, the RFID chip 220 may be set to be an origin for coordinates so as to become a reference point for locations on the wafer 100 in inputting other information. The wafer information may be inputted in real time during a wafer processing operation. Accordingly, additional time for inputting the wafer information may not be necessary.

The wafer equipped with the RFID chip 220 may be transferred to a device, e.g., a device for performing a die-attaching process (S320). The wafer information recorded on the RFID chip 220 of the transferred wafer 100 may be read by the reader 210 (S330).

A method of identifying the wafer information may be as follows. The wafer information may be extracted from the data storage unit 404 as shown in FIG. 6. The wafer information may be converted into an analog signal in the data transmitting unit 230 and the analog signal may be transmitted to the antenna unit 222. The antenna unit 222 may emit the analog signal bearing the wafer information to the outside of the wafer 100. The analog signal emitted from the antenna unit 222 may be read by the reader 210. The wafer information may be identified on a real-time basis. Accordingly, additional time for identifying the wafer information may not be necessary.

The wafer information in the database 404 may be compared with the wafer information in the RFID chip 220 (S340). If the result is determined to be identical, the wafer 100 may be processed according to a fixed order (S350). That is, normal chips may be subjected to subsequent processes and defective chips may be removed. The control unit 406 may determine whether the wafer information in the database 404 is identical to the wafer information in the RFID chip 220.

According to an example embodiment the present invention, it is possible to reduce or prevent an incorrect identification of the wafer information due to external environments by using the RFID chip as an identification unit.

Also, additional time for inputting or identifying the wafer information is not necessary since the wafer information may be input and/or identified in real-time. Further, other wireless signals may be used in place of the RF signal

While the present invention has been described with reference to exemplary embodiments thereof, it will be understood by those skilled in the art that various changes in form and details may be made therein without departing from the scope of the present invention as defined by the following claims.

1. A semiconductor wafer, comprising:
a radio frequency identification (RFID) chip on one side of the semiconductor wafer, on which a pattern has been formed, wherein information on the wafer is input to and/or output from the RFID chip using radio frequency communication.

2. The semiconductor wafer according to claim 1, wherein the information on the wafer refers includes information on processes performed on the semiconductor wafer.

3. The semiconductor wafer according to claim 1, wherein the RFID chip includes:
a data receiving unit receiving the information on the wafer; and
a data transmitting unit transmitting the information on the wafer.

4. The semiconductor wafer according to claim 3, wherein the RFID chip includes a data storage unit storing the information on the wafer.

5. The semiconductor wafer according to claim 1, wherein the RFID chip is formed during processing of the wafer.

6. The semiconductor wafer according to claim 1, wherein the RFID chip is attached to the wafer using an adhesive.

7. The semiconductor wafer according to claim 1, wherein the RFID chip is inserted into a recess in the wafer.

8. The semiconductor wafer according to claim 7, wherein the recess has a depth of 40 μm or less.

9. A method of identifying a semiconductor wafer, comprising:
storing first wafer information on the semiconductor wafer in a database;
inputting the first wafer information to an RFID chip formed on the semiconductor wafer;
reading second wafer information from the RFID chip; and
determining whether the first wafer information is identical to the second wafer information and proceeding to a wafer processing operation if the first wafer information and the second wafer information are the same.

10. The method according to claim 9, wherein the inputting of the first wafer information includes:
receiving an radio frequency (RF) signal containing the first wafer information and occupying a frequency band in an antenna unit;
generating a power source with a voltage from the RF signal;
converting the RF signal into a digital signal;
analyzing data transmitted from the data receiving unit; and
storing the analyzed data.

11. The method according to claim 9, wherein the inputting of the semiconductor wafer information is performed in real-time.

12. The method according to claim 9, wherein a reference point for coordinates required for inputting the first wafer information on the semiconductor wafer is the RFID chip.

13. The method according to claim 9, wherein the first wafer information is input before and after an electrical die sorting (EDS) test.

14. The method according to claim 9, wherein the reading of the second wafer information includes:
extracting the second wafer information from a data storage unit;
transmitting the second wafer information converted into an analog signal;
emitting the analog signal bearing the second wafer information; and
reading the analog signal emitted.

15. The method according to claim 9, wherein the reading of the second wafer information on the semiconductor wafer is performed in real-time.

16. A semiconductor wafer identification system comprising:
a radio frequency identification (RFID) chip for storing wafer information; and
a reader for reading the wafer information stored on the RFID chip.

17. The semiconductor wafer identification system of claim 16, wherein the RFID chip includes an antenna unit, for transmitting and/or receiving an RF signal, a power generating unit, a data receiving unit, a data storage unit, a data transmitting unit, and a data processing unit.

18. The semiconductor wafer identification system of claim 17, wherein the RF signal may occupy a frequency band.

19. The semiconductor wafer identification system of claim 17, wherein the power generating unit generates a power source with a voltage from the RF signal received through the antenna unit.

20. The semiconductor wafer identification system of claim 17, wherein the data receiving unit converts the RF signal received in the antenna unit into a digital signal and transmits the converted signal to the data processing unit.

21. The semiconductor wafer identification system of claim 17, wherein the data processing unit processes data received from the data receiving unit.

22. The semiconductor wafer identification system of claim 17, wherein the data storage unit stores data received from the data receiving unit.

23. The semiconductor wafer identification system of claim 17, wherein the data transmitting unit converts data in the data storage unit.

24. The semiconductor wafer identification system of claim 16, wherein the information on the wafer refers to information of various processes that the semiconductor wafer was subjected to.

25. A radio frequency identification (RFID) chip comprising:
an antenna unit transmitting and/or receiving an RF signal;
a power generating unit generating a power source with a voltage from the RF signal received through the antenna unit;
a data receiving unit converting the RF signal received in the antenna unit into a digital signal and transmitting the converted signal to the data processing unit;
a data storage unit storing data received from the data receiving unit;
a data processing unit processing data received from the data receiving unit; and
a data transmitting unit transmitting the processed data to a reader.

26. The RFID chip of claim 25, wherein the RF signal may occupy a frequency band.

27. A semiconductor wafer including the RFID chip of claim 25.

28. A semiconductor wafer identification system including the RFID chip of claim 25.

29. A semiconductor wafer identification system performing the method of claim 9.
